(19) United States
(12) Patent Application Publication
(10) Pub. No.: US 2008/0050535 A1
(43) Pub. Date: Feb. 28, 2008

(54) Method For The Thermal Treatment Of Powder Paints Applied To Substrates For The Production Of A Coating On The Substrates Using Ir-Radiation

(76) Inventors: Thomas Schmidt, Wels (AT); Gerald Hemedinger, A-Vienna (AT)

Correspondence Address: K.F. ROSS P.C., 5683 RIVERDALE AVENUE, SUITE 203 BOX 900, BRONX, NY, 10471-0900, US

(21) Appl. No.: 10/580,871

(22) PCT Filed: Nov. 26, 2004
(86) PCT No.: PCT/AT04/00418

§ 371 Date: Feb. 8, 2007

(30) Foreign Application Priority Data
Nov. 26, 2003 (AT) A 1898/2003

(51) Int. Cl. C08J 7/18

(52) U.S. Cl. 427/514

(57) ABSTRACT

Method for the thermal treatment of powder paints applied to substrates for the preparation of a coating on the substrates using IR radiation, wherein the powder paint which is applied to the substrate is radiated with middle- and/or long-wave IR radiation and the powder paint contains additives with the characteristic of absorbing middle- and/or long-wave IR radiation. Optionally, the powder paint which is thermally treated with middle- and/or long-wave IR radiation is subjected to a further treatment with electron or UV radiation.

Method for the thermal treatment of powder paints applied to substrates for the preparation of a coating on the substrates using IR radiation.

The invention relates to a method for thermal treatment using IR radiation of powder paints of any shade applied to substrates in order to produce a coating on these substrates.

Due to the high economic viability of the method as well as the favorable assessment in terms of environmental protection in the coating of metallic undersurfaces, powder paints have come to be used in a wide spectrum of applications. The powder coating of—electrically non-conductive—materials such as glass or ceramic is frequently used. In the meantime, applications on temperature-sensitive undersurfaces have also begun to establish themselves. According to currently available processes, any powder paint is initially melted by heating to a temperature above its glass transition temperature following its application. Common heat sources are, for example, convection ovens or infrared radiators. Combinations of the two are also used.

In thermosetting powder coatings, the subsequent curing is done through applied heat. If the curing is done in a convection oven, it is usually done in a temperature range of approximately 140-200° C. for a period of about 10-30 minutes. In so doing, a considerable heating up of the—if applicable, heavy largely thermally absorbent—parts cannot be avoided. In addition, the energy loads resulting from the abovementioned temperatures and the corresponding application times make these heat sources unsuitable for heat-sensitive undersurfaces such as wood and wood-like materials such as medium-density fireboard (MDF), paper, plastics, etc.

The curing of thermosetting powder coatings by means of IR radiation can take place significantly more quickly and hence represents a possibility of avoiding the disadvantages and limitations resulting from the use of convection ovens.

According to WO 99/41323 A1, the especially shortwave NIR (=near infrared) is capable of efficiently curing the most common binding agent systems of thermosetting powder paints, that is to say, capable of heating without the coated substrates; through the high energy density of the NIR radiation used and a sufficient adsorption behavior of the binding agents and some pigments, curing times in the order of seconds are possible. According to DE 198 52 268 C1, it is possible, through careful control of the quantity of barium sulfate and/or aluminum oxide and/or carbon black in the formulations, to adapt powder paints of different colorings in their receptivity to the NIR radiation in such a manner that these coating masses can be cured under similar curing conditions efficiently and in a manner that protects the substrate. Accordingly, WO 99/47276 A1 describes the use of IR radiation which comprises NIR and/or shortwave IR radiation at least in part for the curing of powder paints on heat-sensitive substrates such as wood, wood fiber materials, plastic, rubber, fabric, paper or cardboard, wherein radiation times of 12, preferably 8 seconds are not exceeded. By NIR radiation is meant, in this document, the wavelength range between the visible range and 1.2 μm, and by shortwave IR is meant the wavelength range between 1.2 and 2.0 μm. The drawings enclosed with the aforementioned document represent the use of this curing method on a plate surface as well as on the casing of a cylinder. In both cases, the required equidistant arrangement of the radiators from the object to be coated is possible; in the case of the rotating body, the radiator is arranged axially parallel. The implied rotation of the cylinder makes an even heating of its casing surface during the curing process possible. In the case of the plate, a radiator with a maximum radiation flux density of about 1 μm wavelength is used; in the case of the rotating body, halogen tube radiators are used, which also means a maximum radiation flux density of about 1 μm wavelength. Although it is correct, when looking at the corresponding spectra, to speak of IR radiation which “comprises NIR and/or shortwave IR radiation at least in part” even in these cases, radiation times of a maximum of 12, preferably a maximum of 8 seconds, provide insight into the pronounced NIR emphasis of the radiation spectrum used.

GB 2 055 619 A also relates to the curing of powder coatings on heat-sensitive, cellulose fiber-containing substrates such as wood or materials derived from it. As a result of the disclosure of this document, IR radiation in the wavelength range of 1.0 to 1.5 μm is best suited to curing without overheating these materials. It has been determined that the wavelength range of 1.0 to 1.5 μm can be used and leads to good results.

Preferred ranges are named for the output of the radiators and their distance from the objects to be coated with powder paint. It is explained that the coatings can be thermally damaged under excessive radiant action, and the substrates can be thermally damaged under too little action (before the powder paint is completely cured).

The idea that, when properly executed, the curing of thermoreactive powder coatings takes place through the high energy density of the radiation used for a sufficiently short time that it is closed off before the substrate is reached by considerable or even intolerable heat forms the basis of all of the aforementioned methods which work with IR radiation. However, precisely those set-ups which are required for the generation of NIR radiation require extraordinarily high installed loads and bring about very high energy costs, making these methods and the associated equipment very expensive.

Nevertheless, it turned out that the curing methods for the curing of powder coatings on objects which are based on IR radiation, particularly NIR radiation, are impracticable as soon as profiled surfaces are to be coated instead of flat ones. If the curing times lie in the range of seconds, this requires a defined spacing between radiator and object as well as an extremely precise dosing of the radiation used (duration and intensity). Different distances of different parts of the object from the radiator lead to considerably different thermal action on them. The same applies, for example, if a part of the object is oriented in a planar and perpendicular manner to the incoming NIR radiation, [and] features have sunken profiles—on doors or on the front faces of furniture, for example—but also areas with an abnormal orientation to the radiation. With object geometry of this type, no sufficient curing of the powder paint can be achieved by means of IR radiation, particularly NIR radiation, without thermally damaging the coating mass and, in the case of a heat-sensitive undersurface such as wood or wood-like materials, cardboard or plastic, damaging these in the clearly exposed areas—particularly in the case of undersurfaces with a low thermal conductivity such as glass or ceramic—and/or bringing about flaws on the powder paint applied there through outgassing of moisture from natural materials such as wood, and the products derived from them such as MDF, paper or cardboard.

By substrates of low thermal conductivity are meant, for example, those thermally insulating materials whose thermal conductivity lies between 0.05 and 5 W/mK. The thermal conductivity of MDF, for example, lies at 0.07 W/mK, that of wood at 0.16 W/mK, and of glass at between 0.6 and 1.8 W/mK.

Methods are indeed known, such as the one described in AT 402 265 B, for example, in which heat-sensitive undersurfaces such as wood or wood fiber materials are provided with a liquid base coat before the powder coating which represents a thermal barrier to its undersurface. This is disadvantageous in any case since it requires an additional work step. Moreover, drying times must be accommodated, which requires storage capacity for goods to be dried. If organic solvents are used, the subject of the environment comes into play on top of that, then the costs of this solvent. In summary, it can be considered inconsistent to apply a liquid coating, the use of which lacks the advantages of powder paint, before the advantageous use of powder coatings. UV-setting powder coatings, by contrast, are cured using ultraviolet radiation after their previously performed melting. This melting after application is done produces a coherent liquid phase from the powdery application in which, brought about by UV radiation, the curing of the powder paint binding agent is then performed. In general, objects which are coated with UV-setting powder paints are subjected to a lower temperature load in comparison to thermosetting powder paints. Nonetheless, even these low temperature loads can lead to problems in some materials such as in molded thermoplastic articles, for example, in which the longer action of temperatures around or over 100° C. can already lead to deformations.

In addition, powder paint formulations are also described which can be cured according to the so-called “dual cure” method, a curing method which uses thermal and UV radiation, for example in EP 0 844 286 B1. Here, too, according to the current state of the art, the unavoidable heating of the objects limits the usefulness of powder paints to be thus cured to profiled, particularly temperature-sensitive objects.

EP 0 795 565 B1 describes liquid, solvent-containing resin compositions which block the thermal portion of solar radiation, contain polymerizable (meth)acrylate which possesses a (meth)acryloyl group and which can be cured through the use of UV or electron beams. This document also discloses solar radiation-absorbent particles of inorganic metallic compounds having a primary particle fineness of 0.5 μm or less. The abovementioned EP-B1 also discloses the use of such resin compositions for the preparation of scratch-resistant protective coatings on foils, etc. Vanadium oxide, tin oxide, ATO (antimony-doped tin oxide), ITO (indium-doped tin oxide) and zinc antimonate anhydride are given as examples of those inorganic metallic compounds.

No particles are disclosed as a result of the teaching of the abovementioned document which absorb over the entire IR spectral range. On the contrary, it is characterized as advantageous to combine the aforementioned particles with IR-absorbent, organic compounds such as special amino or phthalocyanine compounds whose absorption covers other ranges of the IR spectrum.

It is therefore the object of the invention to propose a method for the thermal treatment of powder paints of any shade for the preparation of a coating on any substrate while abstaining from the application of a liquid coating which acts as a thermal barrier, by means of which a heating of those substrates associated with thermal loss is avoided to as great an extent as possible. Moreover, it is the object of the invention to create a method which permits the coating of substrates with profiled surfaces—which can optionally be poorly conductive materials such as glass or ceramic and/or heat-sensitive such as wood, wood fiber material, paper, cardboard, plastic, rubber or fabric—without damaging the substrates and/or the coating masses, be it by disintegration and/or deformation, and which leads to an even, trouble-free, cured and well adhering coat of paint. A further object of the invention is to propose a method for the thermal treatment of powder paints of any shade for the preparation of a coating of any substrate which manages without the high installed electrical loads and equipment required for them and as required by NIR technology.

The object of the preparation of a commensurate method is achieved by a method which, according to the invention, is characterized in that the powder paint which is applied to the substrate is irradiated with medium- and/or long-wave IR radiation and that the powder paint contains additives with the characteristic of absorbing medium- and/or long-wave IR radiation and that the powder paint which is thermally treated with medium- and/or long-wave IR radiation is optionally subjected to a further treatment with electron or UV radiation.

During the use of electric radiators with rod-shaped heating elements, an output of 5 to 80 W/cm, preferably 20 to 50 W/cm, is worked with. During the use of gas-catalytic radiators, work is done with an output of between 1.0 and 6, preferably 2 to 4 W/cm².

Further embodiments and modifications of the method according to the invention can be derived from the specification and the subordinate claims.

Surprisingly, it has become apparent that completely or partially thermosetting powder paints of any shade on any objects, particularly poorly thermally conductive ones with a thermal conductivity of between 0.05 and 5 W/mK and/or heat-sensitive objects and, especially preferred, objects with profiled surfaces, can be completely and efficiently cured—that is, without noteworthy heating of the object itself and hence without any damage for the coating and/or the substrate—using medium-wave to long-wave infrared radiation whose maximum radiation flux density lies above wavelengths of 2.0 μm, if the powder paints contain substances with the characteristic of absorbing medium- and/or long-wave IR radiation. The paint surfaces thus achieved are free of imperfections and show no indication of outgassing due to the emission of moisture or thermal disintegration of the undersurface, which manifest as surface blemishes of the powder coating—so-called “pinholes.” In addition, it was possible to observe that UV- and electron beam-setting powder paints which are provided with appropriate additives which are absorbent in the medium- to long-wave IR range melt and form films reliably using the abovementioned type of radiation at a radiation intensity which, without the respective additive, merely brings about an agglomeration of the powder particles. This powder coating thus melted in the liquid phase is then subjected to a UV or electron beam radiation in order to cure it.

The use of antimony tin oxide (Minatec® 230 A-IR of the Merck Co.) in its commensurate powder paint formulations, for example, has proven to be very successful for an efficient curing with the aid of medium-wave to long-wave IR radiation while still protecting the MDF undersurface. Moreover, tin antimonate, vanadium oxide, tin oxide, indium tin oxide (Nano® ITO of the company Nanogate Technologies GmbH, Saarbrücken, Germany) and C nanotubes (of the company Nanoledge, Montpelier, France) as well as C nanofibers (of the company Electrovac GesmbH, Klosterneuburg, Austria) have exhibited outstanding efficiency.

Other noteworthy classes of material with high effectiveness in terms of the present invention are the oxides of the rare-earth metals. They exhibit a clearly pronounced effect in pure form, in the form of mixtures of the individual pure substances and as oxides of the respective rare-earth metal mixtures as well.

Furthermore, organic substances with a high component of hydroxyl groups of at least 0.5 hydroxyl groups per C atom have also exhibited medium- and/or long-wave IR radiation absorption effectiveness in terms of the present invention. Examples of such organic substances are carbohydrates (cellulose fibers or powder, starch, lactose) or polyalcohols such as pentaerytlrite, di-pentaerythrite, for example.

The required quantity of additive, with respect to the powder paint, depends on the substance which absorbs in the medium to long-wave IR range, the energy required by the powder paint system in order to melt and to cure, the heat-sensitivity of the substrate to be coated and the emission spectrum of the radiation source being used.

When using an IR radiator which is operated with electrical energy (Heraeus Co.), additions of Nano® ITO, C nanofibers and C nanotubes in the range of 0.01% with respect to the total powder paint formulation exhibited outstanding effectiveness with regard to the curing of such formulations, while the non-modified compositions of such powder paints do not cure at all under these conditions. The radiator (of the companies Infragas Nova Impianti, Italy; Vulcan Catalytic, USA) which are operated with gas as an energy carrier preferably emit in the wavelength range of 2-12 μm. Compared with electric radiators, that distinguish themselves by their very low operating costs. They are suited to the gentle curing of powder coatings on profiled surfaces of objects made of heat-sensitive materials, particularly if the respective formulations contain, for example, 2.5% ytterbium oxide and 2.5% neodymium oxide. The addition of 1-5% Minatec® 230 A-IR fulfills the same purpose. It is of course possible to prepare powder paints through the combined use of respective additives in such a manner that they are suitable for curing according-to the invention with different radiation sources for medium- and/or long-wave IR radiation.

The aforementioned additives with the characteristic of absorbing medium- and/or long-wave IR radiation can be used individually and in combination with each other in the thermal treatment of powder paints which can be applied to substrates.

Due to the substantially lower energy density of the medium- and/or long-wave IR radiation used—in comparison to the methods based on NIR and/or shortwave IR—the curing times for the powder paints on temperature-sensitive substrates which are prepared with the respective absorbers lie in the order of minutes (1-5 minutes, for example) and not—as is the case there—in the order of seconds. Since medium-wave and long-wave radiation, especially that which is generated with gas-catalytic radiators, has a predominantly diffuse character, it copes much better with the demands of curing profiled surfaces of temperature-sensitive substrates than NIR and IR radiation, which can be essentially characterized as being focussed. The doping of the powder paints with absorbers for medium- and/or long-wave IR brings with it the characteristic that the coatings preferably absorb the radiation, quickly melt and cure as desired.

In principle, all binding systems commonly used for the preparation of thermosetting powder paints can be used for the preparation of the thermosetting powder paint formulations according to the inventive method, including polyesters, polyurethanes, polyester epoxy hybrids, polyester polyacrylate hybrids, pure epoxides based on bisphenol A or epoxied phenol novolacs, epoxy polyacrylate hybrids, pure polyacrylates, etc., for example. Suitable as curing agents of the aforementioned polymers are substances such as triglycidyl isocyanurate, diglycyl terephthalate either in pure form or in combination with triglycidyl trimellitate, isocyanate curing agents which are based on diisocyanate adducts, di- or trimers which are optionally inhibited from a premature reaction through the use of detachable blocking agents such as ε-caprolactam, glycoluril (Powderlink® 1174 of the company Cytec Industries Inc.), β-hydroxy alkylamides, imidazoles and their epoxide adducts, imidazolines and their epoxide adducts, polyamines and their epoxide adducts, dicyanamide, novolacs, dodecanedioic acid polyanhydride, etc., for example.

Powder paints for curing according to the inventive method can be laced with all known pigments, including titanium dioxide, carbon black, iron oxides, chromium (III) oxide, ultramarine blue, phthalocyanine blue and green, for example. Likewise, the use of effect pigments, for example those based on aluminum, brass and copper platelets, is possible, as well as mineral effect agents such as mica or iron mica, for example. Barite, calcite, dolomite, quartz, wollastonite, aluminum hydroxide, kaolin, and talc, for example, can also be used as fillers.

In addition, the thermosetting powder paints according to the inventive method can contain, for example, additives for degassing (benzoin, amide waxes, for example), leveling agents (polyacrylates, for example), curing accelerators (tertiary amines, imidazoles, imidazolines, quaternary ammonium and/or phosphonium salts, organic tin compounds, tin soaps, lithium soaps, sulfonic acid and its salts, for example), light-protection agents [UV absorbers, HALS compounds (=hindered amine light stabilizer)], tribo additives (tertiary amines, HALS compounds), waxes, polymer particles such as Teflon, polyamide, polyethylene, or polypropylene as structuring agents and/or to increase the scratch-resistance.

The preparation of powder paints which contain the IR-absorbent substances is done, according to the most common method, through extrusion of the intimate dry mixture of the powder paint raw materials being used, grinding of the extrudate and subsequent sifting. Solvent processes can also be used in place of the melting process in the extruder for the purpose of materially homogenizing the powder paint components. The coating powder can be obtained through the use of a solvent through spray-drying. If, in the place of a solvent, supercritical gas (supercritical carbon dioxide, for example) is used, the process step of the classic spray-drying can be skipped; it is sufficient in this case to expand the obtained mixture via a nozzle to normal conditions.

The application of the powder paints which are suitable for the method according to the invention onto the objects to be coated is done through spraying of the powder paint particles under a simultaneous electrostatic or tribostatic charge. Special variations of this form of application are, for example, application using the EMB® process (electromagnetic brush method) or using the so-called powder cloud method.

After successful application of the powdery coating material on non-developable three-dimensional objects made of heat-sensitive materials, it can then be melted and cured in a trouble-free manner according to the invention with the aid of medium-wave to long-wave IR radiation in all areas of these objects and without damaging them.

The following examples are intended to illustrate the usefulness of the invention in more detail without limiting it to the explanations provided here.

Treatment of thermosetting powder-paints

| | Formulation no. | | | | | | | | | | |
|---|---|---|---|---|---|---|---|---|---|---|---|
| Raw material | C1 | 1 | 2 | 3 | 4 | 5 | 6 | 7 | 8 | 9 | 10 |
| Crylcoat 7207 | 383.0 | 382.9 | 382.9 | 382.4 | 382.9 | 357.0 | 378.0 | 357.0 | 357.0 | 357.0 | 382.8 |
| Araldite GT 6063 | 340.7 | 340.7 | 340.7 | 340.3 | 340.7 | 316.7 | 335.7 | 316.7 | 316.7 | 316.7 | 340.7 |
| Reafree C4705-10 | 25.0 | 25.0 | 25.0 | 25.0 | 25.0 | 25.0 | 25.0 | 25.0 | 25.0 | 25.0 | 25.0 |
| Dyhard MI-C | 3.7 | 3.7 | 3.7 | 3.7 | 3.7 | 3.7 | 3.7 | 3.7 | 3.7 | 3.7 | 3.7 |
| Lanco Wax TF 1830 | 15.0 | 15.0 | 15.0 | 15.0 | 15.0 | 15.0 | 15.0 | 15.0 | 15.0 | 15.0 | 15.0 |
| Tinuvin 144 | 2.0 | 2.0 | 2.0 | 2.0 | 2.0 | 2.0 | 2.0 | 2.0 | 2.0 | 2.0 | 2.0 |
| Bayferrox 3920 | 2.6 | 2.6 | 2.6 | 2.6 | 2.6 | 2.6 | 2.6 | 2.6 | 2.6 | 2.6 | 2.6 |
| Titanium Tiona RCL | 197.6 | 197.6 | 197.6 | 197.6 | 197.6 | 197.6 | 197.6 | 197.6 | 197.6 | 197.6 | 197.6 |
| 696 | | | | | | | | | | | |
| China Clay Extra St | 30.0 | 30.0 | 30.0 | 30.0 | 30.0 | 30.0 | 30.0 | 30.0 | 30.0 | 30.0 | 30.0 |
| Gema | | | | | | | | | | | |
| NANO-ITO | — | 0.1 | — | — | — | — | — | — | — | — | 0.2 |
| C Nanofibers | — | — | 0.1 | 1.0 | — | — | — | — | — | — | — |
| C Nanotubes | — | — | — | — | 0.1 | — | — | — | — | — | — |
| Ytterbium oxide | — | — | — | — | — | 25.0 | — | — | — | — | — |
| Neodymium oxide | — | — | — | — | — | 25.0 | — | — | — | — | — |
| Minatec 230 A-IR | — | — | — | — | — | — | 10.0 | 50.0 | — | — | — |
| Corn starch | — | — | — | — | — | — | — | — | 50.0 | — | — |
| Technocel 40¹ | — | — | — | — | — | — | — | — | — | 50.0 | — |

Numbers indicate raw material quantities in grams
¹Cellulose of CFF GmbH, D-90708 Gehren

The initial components of the C 1 formulations above (comparison example 1) as well as 1-10 (examples according to the invention) are mixed in a Prism Pilot 3 laboratory mixer for one minute at 1500 rpm and then extruded in a laboratory extruder of the type Theyson TSK PCE 20/24D (zone temperatures 40/60/80/80° C.) at 400 rpm. The extrudates obtained are then ground to a grain size of <100 μm.

The powder paints thus obtained are applied using Gema Easy Tronic coating equipment onto furniture store fronts made of MDF with marked profiling (final layer thickness approx. 80 μm) and then subjected to thermal treatment for curing through medium-wave to long-wave IR irradiation with a maximum radiation flux density of >2 μm wavelength. For this purpose, two IR baking units are available:

A) Electrically operated:

4 radiators of the Heraeus Co. (2 medium wave carbon radiators, 2 conventional medium wave radiators, both with a maximum radiation temperature of <1000° C., hence maximum radiation flux density of >2 μm wavelength) are arranged perpendicular to the transporting direction such that they are distributed over the length. For the experiments, the radiators are operated at 60% of their maximum output, which shifts the emitted radiation further into the long-wave range. The belt speed is selected in such a manner that the specimens pass over the curing segment in approximately 3.5 minutes. For the first 30 seconds, the surface temperature lies at approximately 100° C., and then at an average of 135° C.

B) Gas-catalytically operated:

A curing segment of about 10 m is provided with gas-catalytic IR radiators of the Vulcan Co. According to information from the manufacturer, the maximum radiation flux density is approximately 4.5 μm at a radiator temperature of 400° C., and approximately 3 μm at a radiator temperature of 530° C. For the experiments, the radiator output is set in such a manner that an uncoated MDF plate does not exhibit any changes after a pass through the system lasting 4.5 minutes.

Experimental results for the curing of powder paint formulations (determination of the resilience to methyl ethyl ketone):

| | Chemical resiliency [min] | |
|---|---|---|
| Experiment number | System A (electric) | System B (gas-catalytic) |
| C 1 | <1 | 4-5 |
| 1 | 9 | 4-5 |
| 2 | >10 | 4-5 |
| 3 | >10 | >10 |
| 4 | 9 | 4-5 |
| 5 | 1 | 10 |
| 6 | 2 | 9 |
| 7 | >10 | >10 |
| 8 | 2 | 8 |
| 9 | 2 | 8 |
| 10 | >10 | 8-9 |

The characteristic of chemical resilience is used in order to evaluate the curing density of the powder paint which is achieved through baking.

Execution: Methyl ethyl ketone is dripped at room temperature onto the surface to be tested and the time is measured in minutes after which the paint can be wiped away at least partially with a cellulose cloth under moderate pressure or at least partially from the undersurface. If the powder paint resists the solvent for 10 minutes, the test is terminated and [the paint] is considered to have passed the test.

In non-inventive comparison example C (without addition of absorbers), no curing is achieved through the thermal treatment in the electrical system (the powder paint can be washed off), and the curing of this powder paint is clearly insufficient in the gas-catalytic system at any rate.

The following examples 1-10 according to the invention, both on the flat and the profiled parts of the test objects, show that, with the selected doping of IR absorbers which absorb in the medium and/or long-wave IR range, a good to complete curing of the respective powder paints can be achieved in at least one of the baking units used.

Thermal treatment of UV-setting powder paints

Formulation no.

| Raw material | C 2 | 11 |
|---|---|---|
| Uvecoat 3000 | 670.0 | 660.0 |
| Irgacure 819 | 23.0 | 23.0 |
| Irgacure 2959 | 4.0 | 4.0 |
| Resiflow PV 88 100% | 15.0 | 15.0 |
| Tinuvin 144 | 3.0 | 3.0 |
| Titanium 2160 | 200.0 | 200.0 |
| Sachtleben Micro | 55.0 | 45.0 |
| Martinal OL 104 | 30.0 | 20.0 |
| Minatec 230 A-IR | — | 30.0 |

Numbers indicate raw material quantities in grams

Numbers indicate raw material quantities in grams

As has already been described above, the initial components of the C 2 formulations above (comparison example 2) as well as 11 (example according to the invention) are mixed in a Prism Pilot 3 laboratory mixer for one minute at 1500 rpm and then extruded in a laboratory extruder of type Theyson TSK PCE 20/24D (zone temperatures 40/60/80/80° C.) at 400 rpm. The extrudates obtained are then ground to a grain size of <100 μm.

The powder paints thus obtained are applied using Gema Easy Tronic coating equipment onto furniture store fronts made of MDF with marked profiling and then subjected to thermal treatment in the previously described system A. For these experiments, the radiators are operated at 50% of their maximum output, and the belt speed is selected in such a manner that the specimens pass over the treatment segment in approximately 2 minutes.

A visual inspection of the test pieces provided with the coating powders in formulation no. 11 (according to the invention) results in a homogeneously flowing coat of paint which is homogeneously melted throughout all areas and cures using UV without problems; in formulation no. C 2 (non-inventive), one sees an only partially melted layer in the profile areas in which the individual powder grains are still visible. UV setting cannot be carried out on powder paint which is in such a state.

Determination of the surface temperatures of powder-coated MDF parts during transport through System A:

Two MDF test plates of the same kind are each provided with a temperature sensor, and one is provided with the comparison formulation C 1 while the other is provided with the formulation from example 7. Subsequently, the two test plates are run through the constantly operating baking system A at the same speed, and the resulting surface temperatures are recorded with the aid of a DataPaq 11 measurement and recording device. In so doing, it became apparent that the. coating produced from formulation 7 exhibited a temperature throughout the process which was approximately 20±5° C. higher than that of coating produced from formulation C 1.

This measurement proves, in an impressive manner, how a sufficiently moderate medium-wave to long-wave IR radiation intensity, which is unable to damage parts and cannot cure powder paint, leads to the complete curing of the powder paint when a suitable absorber is used in it.

1. A method for the thermal treatment of powder paints of any shade applied to substrates for the preparation of a coating on the substrates using IR radiation, characterized in that the powder paint applied to the substrate is irradiated with medium- and/or long-wave IR radiation, and that the powder paint contains additives with the characteristic of absorbing medium- and/or long-wave IR radiation, and that the powder paint which has been thermally treated with medium- and/or long-wave IR radiation is optionally subjected to further treatment with electron or UV radiation.

2. The method according to claim 1, characterized in that the powder paint is irradiated with a medium- and/or long-wave IR radiation with a wavelength range of 2 to 12 gm.

3. The method according to claim 1, characterized in that the medium- and/or long-wave IR radiation has a maximum radiation flux density at wavelengths of >2.0 gm.

4. The method according to claim 3, characterized in that the maximum radiation flux density of the medium- and/or long-wave IR radiation is at wavelengths in the range of 2.0 to 9.0 gm, especially preferably between 2.0 and 6 gm.

5. The method according to claim 1, characterized in that the additive with the characteristic of absorbing medium- and/or long-wave IR radiation which is contained in the powder paint is antimony tin oxide and/or indium tin oxide.

6. The method according to claim 1, characterized in that the additive with the characteristic of absorbing medium- and/or long-wave IR radiation which is contained in the powder paint is zinc antimonate, vanadium oxide, tin oxide.

7. The method according to claim 1, characterized in that the additives with the characteristic of absorbing medium- and/or long-wave IR radiation which are contained in the powder paint are C nanotubes and/or C nanofibers.

8. The method according to claim 7, characterized in that the C nanotubes and/or C nanofibers are contained in a quantity in the range of 0.01 wt. % with respect to the total powder paint formulation.

9. The method according to claim 1, characterized in that the additives with the characteristic of absorbing medium- and/or long-wave IR radiation which are contained in the powder paint are rare-earth metals and/or oxides of the rare-earth metals or mixtures thereof.

10. The method according to claim 9, characterized in that ytterbium oxide and/or neodymium oxide are contained in the powder paint as additives with the characteristic of absorbing medium- and/or long-wave IR radiation.

11. The method according to claim 1, characterized in that ytterbium oxide and/or neodymium oxide are contained in the powder paint in a quantity of 2.5 wt. % each with respect to the total powder paint formulation.

12. The method according to claim 1, characterized in that the additives with the characteristic of absorbing medium- and/or long-wave IR radiation which are contained in the powder paint are organic substances with a component of hydroxyl groups which is at least 0.5 hydroxyl groups-per C atom.

13. The method according to claim 12, characterized in that the organic substances are carbohydrates such as cellulose fibers or powder, starch, lactose.

14. The method according to claim 12, characterized in that the organic substances are polyalcohols such as pentaerythrite, di-pentaerythrite.

15. The method according to claim 1, characterized in that the substrate on which the applied powder paint is irradiated with medium- and/or long-wave IR radiation is three-dimensional.

16. The method according to claim 1, characterized in that the substrate on which the applied powder paint is irradiated with medium- and/or long-wave IR radiation is made of thermally insulating material with a thermal conductivity of between 0.05 and 5 W/mK.

17. The method according to claim 1, characterized in that the substrate on which the applied powder paint is irradiated with medium- and/or long-wave IR radiation is made of heat-sensitive material.
